(19) United States
(12) Patent Application Publication
(10) Pub. No.: US 2023/0065333 A1
(43) Pub. Date: Mar. 2, 2023

(54) Vehicle Gun Rack

(71) Applicant: Brian Goldwitz, Waterbury, CT (US)

(72) Inventor: Brian Goldwitz, Waterbury, CT (US)

(21) Appl. No.: 17/895,048

(22) Filed: Aug. 24, 2022

Related U.S. Application Data
(60) Provisional application No. 63/236,681, filed on Aug. 24, 2021.

(51) Int. Cl. B60R 7/14; A47B 81/00

(52) U.S. Cl. CPC B60R 7/14; A47B 81/005

(57) ABSTRACT

The current invention is a gun rack that can be placed in a vehicle such as a jeep. It can be place in the back by a window or in the hatchback area of the vehicle. The rack has a foldable frame which has a base that attaches to the vehicle. The base has a plurality of foldable brackets that extend away from the base which can hold firearms.

### RELATED APPLICATIONS

This application is the non-provisional of provisional application 63/236,681 filed on Aug. 24, 2021 and claims its priority date.

### TECHNICAL FIELD

The technology discussed below relates a vehicle gun rack and more particularly one that works with SUV and jeeps.

### BACKGROUND

People need to store and transport their firearms while driving their SUV (“Sports Utility Vehicle”).

There are a number of ways to do this but there needs to be a way to completely secure firearms while traveling. Safety is very important while storing firearms while traveling.

There is still room for improvement in the art.

### SUMMARY

The current invention is a gun rack that can be placed in a vehicle such as a jeep. It can be place in the back by a window or in the hatchback area of the vehicle. The rack has a foldable frame which has a base that attaches to the vehicle. The base has a plurality of foldable brackets that extend away from the base. These brackets are used to hold a firearm. The gun rack has an open bracket where the firearm can be placed and the bracket can be closed securing the handle of the firearm. It can hold a multiple number of types of firearms. The top of the frame can fold down to stabilize and secure the frame.

These are improvements over the current art.

### DRAWINGS

FIG. 1 is a display of a gun rack that can be placed in a vehicle;

FIG. 2 shows the gun rack with the gun brackets folded in;

FIG. 3 shows the gun brackets open;

FIG. 4 shows the gun bracket in a holding position;

FIG. 5 shows the gun rack with a rifle going into it; and

FIG. 6 shows a rifle in the gun rack.

### DETAILED DESCRIPTION

The illustrations presented herein are, in some instances, not actual views of any particular framing devices or components thereof, but may be idealized representations which are employed to describe the present disclosure. Additionally, elements common between figures may retain the same numerical designation.

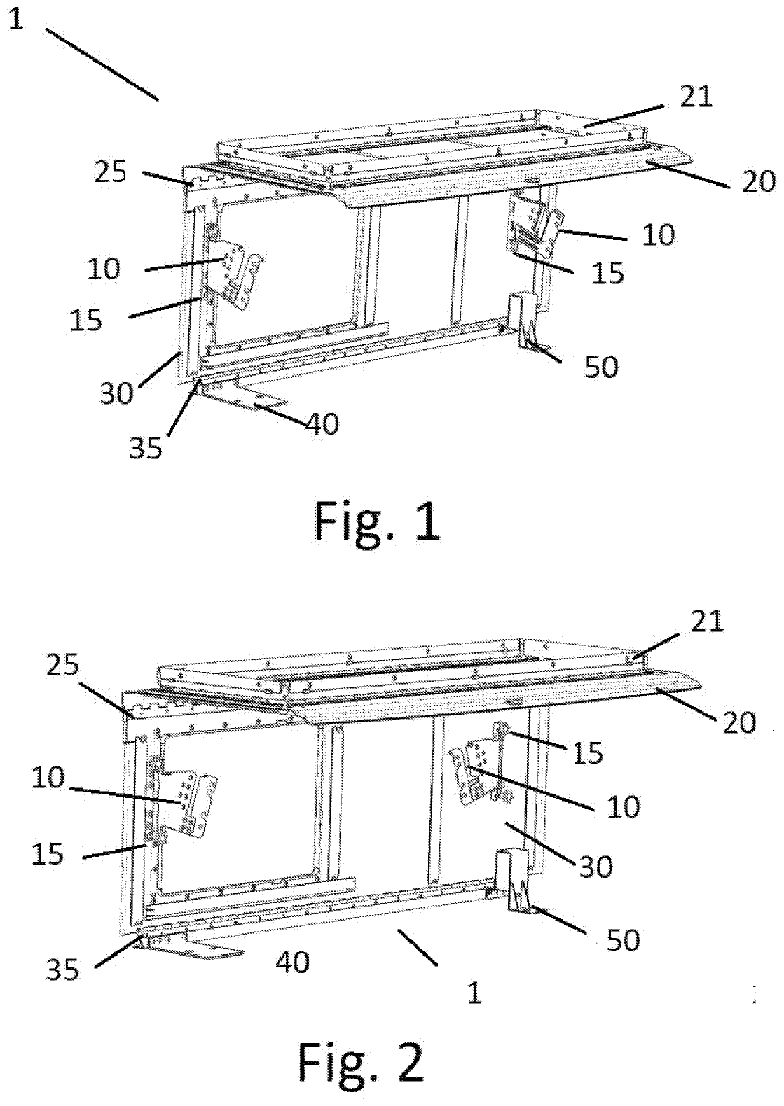

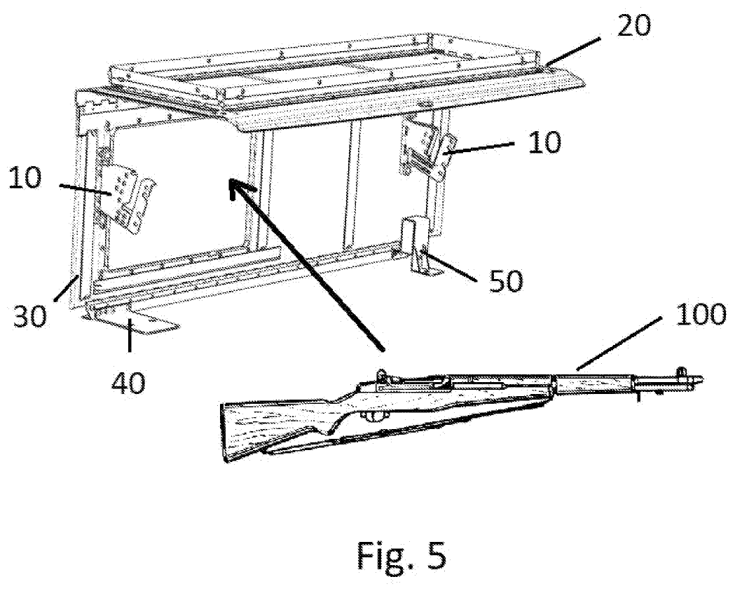

The current invention is an improved vehicle gun rack 1 as shown in FIGS. 1 through 6 that can hold a multiple number of types of firearms 100.

FIGS. 1 through 6 shows a gun rack 1 that can be placed in a vehicle such as a jeep. It can be place in the back by a window or in the hatchback area of the vehicle. The rack 1 has a foldable frame with a base 30, a cover 20 and attachment brackets 40, 50.

The attachment brackets 40, 50 attach the rack 1 to the vehicle. One is a flat bracket 30 with a flat side with a raised end that can be attached to the vehicle and the base 30 using an attachment means such as bolts, screws or adhesive. Another is a angled bracket 50 with a smaller flat footprint with two angled sides that connect to a support rectangle that is attached to the base 30. The support rectangle will provide support to keep the base 30 from directly contacting the cover 20 or the surface of the vehicle. It is attached the to base 30 and the vehicle using an attachment means such as bolts, screws or adhesive.

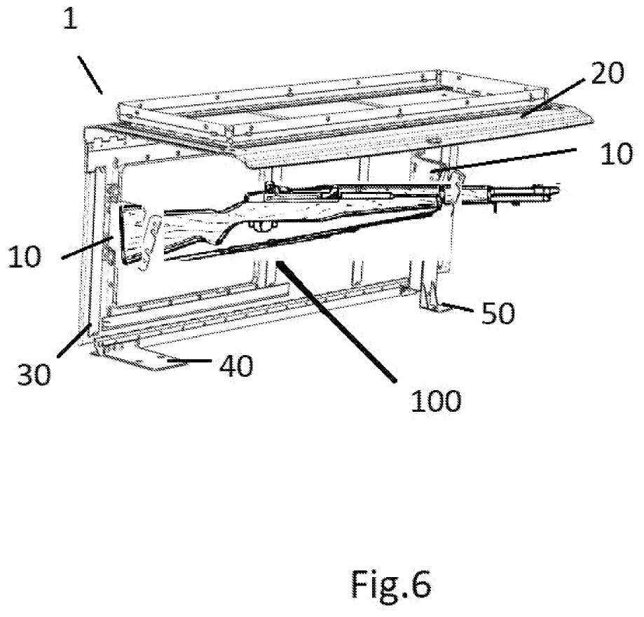

The base 30, in the preferred embodiment will be rectangular in shape with a left and right side. It will have a base hinge 35 with is attached to the brackets 40, 50 and allow the base 30 to be folded down towards the surface of the vehicle. The base 30 will have a plurality of brackets 10 set in parallel pairs with one of the pair attached to the left side of the base and other one of the pair attached to the right side of the base 30. These brackets 10 can be extended out to hold the firearm 100 as shown in FIG. 6 or folded in flat with the base 30 has shown in FIG. 2.

The rack 1 will have a cover 20 that is connected to the base 30 with a cover hinge 25. The cover hinge 25 allows the cover 20 to fold down to stabilize and secure the base 30. The cover 20 can have a cover bracket 21 to help secure and provide strength to the cover 20. The cover 20 in rectangular in shape and similar in size to the base 30.

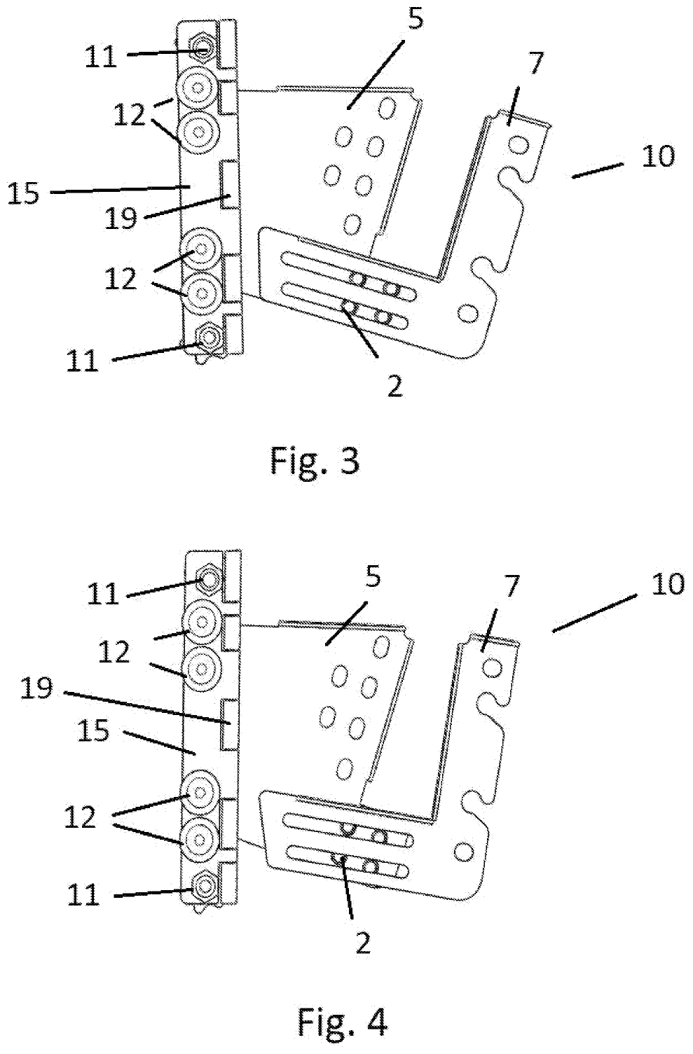

The base 30 has a plurality of foldable brackets 10 that extend away from the base. These brackets 10 are used to hold a firearm 100. FIG. 3 shows an open bracket 10 where the firearm 100 can be placed. FIG. 4 shows how the bracket 10 can be closed securing the handle of the firearm 100.

The brackets 10 are attached to the base 30 by an attachment plate 15. The brackets 10 are attached to the bracket attachment plate 15 by a bracket hinge 19. The bracket hinge 19 allows the brackets 10 to be folded or turned so they are flat with the base 30.

The bracket attachment plates 15 are attached to the base 30 using an attachment means such as bolts and nuts 11, screws 12, adhesive or welding. The brackets 10 have to main components consisting of a bracket base 5 and securing plate 7. A firearm 100 is inserted into the channel made by the bracket base 5 and securing plate 7 as shown in FIGS. 3, 4 and 6. The bracket base 5 has a flat top that angles slightly up from the base 30 and a front side that angles towards the base 30 at an approximately 45 degree angle to a bottom extension that extends away from the base 30 at a downward angle. The bottom extension has plurality of compression rollers 2 that extend out away from the bottom extension. The securing plate 7 is in the shape of a backward “L” with a plurality of channels in the bottom of the securing plate 7. The rollers 2 are placed into the channels attaching the securing plate 7 to the bracket base 5. When placing the firearm 100 into the bracket 10 the opening formed by the securing plate 7 and the bracket base 5 is an open rectangle as should in FIG. 3. Once the firearm 100 is placed in the opening the securing plate 7 is turned in against the compression rollers 2 compressing the securing plate 7 against the firearms and securing the firearm 100 in place as shown in FIGS. 4 and 6. To unsecure the firearm 100 the securing plate 7 is aligned again with the rollers allowing the firearm to be removed. The securing plate 7 can be moved forward or backward on the compression rollers 2 to adjust to the size of the firearm 100.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art.

What is claimed is:

1. A device comprising:
a gun rack with a foldable frame having a base with a plurality pairs of foldable brackets attached to the base.

2. The device according to claim 1 further comprising:
having a cover attached to the base.

3. The device according to claim 1 further comprising:
having a plurality of attachment brackets.
